(19) United States
(12) Patent Application Publication
(10) Pub. No.: US 2012/0299702 A1
(43) Pub. Date: Nov. 29, 2012

(54) HYBRID POSITIONING SYSTEM

(75) Inventors: Thandava Krishna Edara, Peoria, IL (US); Eric Alan Reiners, Washington, IL (US); Dexter Grant Travis, Kyle, TX (US); Frank Arthur Willis, Mapleton, IL (US)

(73) Assignee: CATERPILLAR INC.

(21) Appl. No.: 13/116,954

(22) Filed: May 26, 2011

(51) Int. Cl. G08B 5/22

(52) U.S. Cl. 340/8.1

(57) ABSTRACT

A system for determining a position of a machine within a job site comprises at least one position monitoring device configured to collect information indicative of a location of the machine and a processor, communicatively coupled to the at least one position monitoring device. The processor is configured to estimate a location of the machine based on the received information using a first positioning technique. The processor is also configured to determine a first error value associated with the estimated location of the machine and compare the first error value with a threshold error level. If the first error value exceeds the threshold error level, the processor is configured to receive second information indicative of the location of the machine and determine the location of the machine based on the received second information, wherein the location of the machine is determined using a second positioning technique.

### TECHNICAL FIELD

The present disclosure relates generally to positioning systems and, more particularly, to a hybrid positioning system for autonomous machines.

### BACKGROUND

Many commercial and industrial job-sites rely on positioning systems for determining the location of machines and other equipment operating within the job-site. For example, machines and, in particular, mobile machines, may be equipped with satellite-based positioning technology, such as a global positioning system (GPS). GPS and other satellite-based positioning systems are generally effective at determining a machine's position in terms of latitude and longitude coordinates and elevation. In general, however, satellite-based position systems alone do not effectively determine a machine's position relative to mobile vehicles, unmarked obstacles, boundaries, and potential hazards within a job-site.

Moreover, certain job-sites may employ machines that can be operated in an autonomous or semi-autonomous mode. These machines may be configured to perform one or more tasks without requiring direct commands from—or even the presence of—a human operator aboard the machine. To compensate for the lack of a human operator, many autonomous machines employ integrated on-board navigation, guidance, and collision avoidance systems to operate and control the machine in and around the job site. These systems are typically used in addition to satellite-based positioning systems, and are especially useful where satellite-based positioning data cannot be obtained due to communication interruptions between the on-board receiver and the satellite.

On-board navigation and guidance systems typically include sensors that are mounted on the machine and configured to aid in determining a location, orientation, and/or position of the machine as it navigates within the job-site. Some navigation systems use a technique called Simultaneous Localization And Mapping (“SLAM”), which uses the sensor information to generate a map of the job-site that is used by the navigation system of the machine. Specifically, SLAM uses sensors mounted on the machine to determine the position, orientation, and distance of the machine from fixed landmarks and electronic beacons located within the job-site. Based location information, an on-board computer system can generate a detailed map of the work environment that, along with the sensor information, can be used by the machine to navigate within the work environment.

Because the conventional SLAM technique involves continuously measuring sensor data and maintaining a job-site map in real-time based on the sensor data, it can require large amounts of processing power and memory. Such requirements are not only expensive, they can consume a sizeable portion of the available computing resources of the machine.

One solution for reducing the amount of memory required to support SLAM-based systems is described U.S. Pat. No. 7,272,467 (“the '467 patent”). The '467 patent describes an autonomous robot that identifies its surroundings using the SLAM technique. Based on the identified surroundings, the robot estimates it location and loads a small map corresponding this estimated location into active memory. According to the '467 patent, if, after a “relatively long period of time,” the robot cannot properly identify its precise location from the map information stored in active memory, it loads the entire map of the area from a database repository to ascertain its location within the mapped environment.

Although the system described in the '467 may reduce overall burden on active memory in certain situations, it may still be inadequate. For example, by waiting a “relatively long period of time” after the machine is unable to locate its position before downloading additional information, the system of the '467 patent allows the machine to operate without sufficient location information. Such operation can be problematic, particularly in crowded and potentially hazardous work environments, where precise machine location information may be critical.

The presently disclosed hybrid navigation system and associated methods are directed toward overcoming one or more of the problems set forth above and/or the problems in the art.

### SUMMARY

In accordance with one aspect, the present disclosure is directed to a method for determining a position of a machine within a job site. The method may comprise receiving first information indicative of a location of the machine and estimating a location of the machine based on the received first information using a first positioning technique. A first error value associated with the estimated location of the machine may be determined and compared with a threshold error level. If the first error value exceeds the threshold error level, second information indicative of the location of the machine may be received. The location of the machine may be determined based on the received second information using a second positioning technique.

According to another aspect, the present disclosure is directed to an alternative method for determining a position of a machine in a job site. The method may comprise receiving information indicative of a location of the machine and estimating a location of the machine based on the received information. A first error value associated with the estimated location of the machine may be determined and compared with a threshold error level. If the first error value exceeds the threshold error level, at least one landmark proximate the machine may be identified and a map portion associated with the at least one identified landmark may be selected. The received information indicative of the location of the machine may be analyzed with respect to the selected map portion and, based on the analysis, the location of the machine may be determined.

In accordance with another aspect, the present disclosure is directed to a system for determining a position of a machine in a job site. The system may comprise at least one position monitoring device configured to receive information indicative of a location of the machine and a processor, communicatively coupled to the at least one position monitoring device. The processor may be configured to estimate a location of the machine based on the received information using a first positioning technique and determine a first error value associated with the estimated location of the machine. The processor may compare the first error value with a threshold error level and, if the first error value exceeds the threshold error level, receive second information indicative of the location of the machine. The processor may determine the location of the machine based on the received second information using a second positioning technique.

### BRIEF DESCRIPTION OF THE DRAWINGS

FIG. 1 illustrates an exemplary job-site in processes consistent with the disclosed embodiments may be implemented;

FIG. 2 illustrates an exemplary machine in accordance with the certain disclosed embodiments;

FIG. 3 provides a schematic diagram of certain components associated with an exemplary machine positioning system, consistent with the disclosed embodiments;

FIG. 4 provides a flowchart depicting an exemplary method for determining a location of a machine within a job-site, consistent with the disclosed embodiments; and

FIG. 5 depicts an exemplary timing diagram consistent with certain processes described in accordance with the disclosed embodiments.

### DETAILED DESCRIPTION

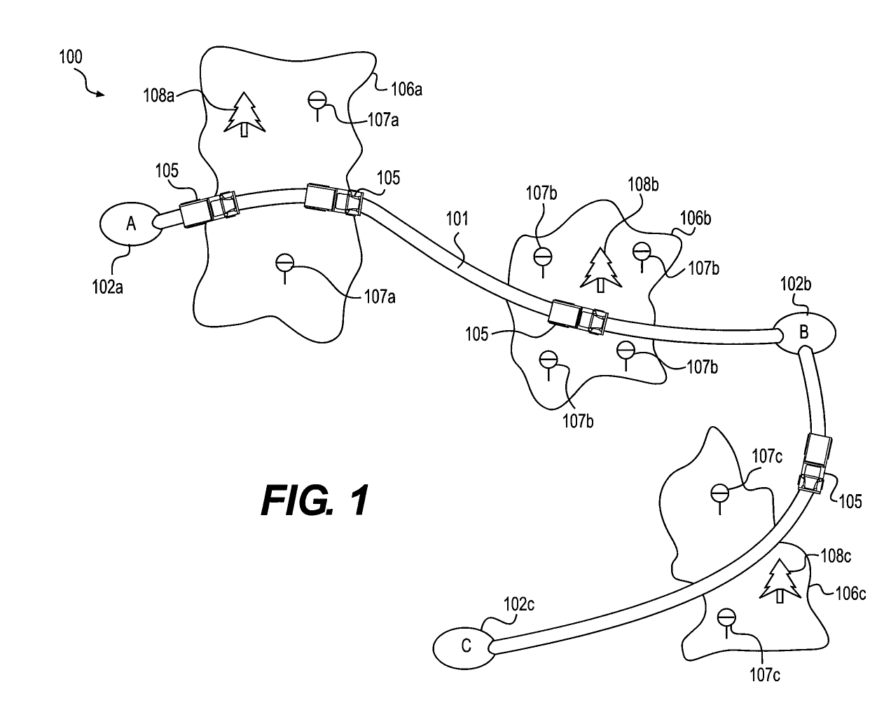

FIG. 1 illustrates an exemplary job-site 100, in which systems and methods for determining a location of one or more machines 105 may be implemented consistent with the disclosed embodiments. Job-site 100 may include systems and devices that cooperate to perform a commercial or industrial task, such as mining, construction, energy exploration and/or generation, manufacturing, transportation, agriculture, or any task associated with other types of industries. According to the exemplary embodiment illustrated in FIG. 1, job-site 100 may include a haul road 101 on which one or more machines 105 may transport material between one or more locations 102a, 102b, 102c.

As illustrated in FIG. 1, machines 105 may be one or more transport machines. Transport machines may embody any machine that is configured to transport materials within job-site 100 such as, for example, articulated trucks, haulers, on-highway or off-highway trucks, dump trucks, or any other machine adapted to transport materials within or around job-site 100. Although machines 105 are illustrated as transport machines, it is contemplated that job-site 100 may employ any type of machine configured to perform a task associated with job-site 101. For example, machines 105 may embody mining equipment (such as mining vehicles, excavators, drills, bucket loaders, tractors, material handlers), road building and repair equipment (such as motor graders, planers, wheel-tractor scrapers), or any suitable fixed or mobile machine that may contribute to the operation of a task associated with job-site 100.

As illustrated in FIG. 1, job-site 100 may include haul road 101, which may be used by machines 105 to travel within job-site 100 (for example, between locations 102a, 102b, 102c). Job-site 100 may include one or more sub-regions, the outer bounds of which may be defined by respective boundaries 106a, 106b, 106c. Each sub-region may include one or more landmarks, such as natural landmarks 107a, 107b, 107c or beacons 108a, 108b, 108c.

Each sub-region may correspond with areas that lack reliable coverage by conventional positioning technologies, such as satellite-based positioning systems (e.g., GPS, GLOSNASS, Compass, Galileo, etc.) As such, a user or manager of job-site 100 may define respective boundaries 106a, 106b, 106c around each of these regions to denote regions where alternative positioning methods may be employed to compensate for the lack of reliable satellite-based positioning coverage.

Boundaries 106a, 106b, 106c may be defined and/or marked electronically using, for example, lasers, RF markers, electronic beacons, or any suitable system for marking boundaries such that a corresponding electronic boundary detector can responsively identify when the area defined by the boundary has been entered. As such, when a machine enters the sub-regions defined by boundaries 106a, 106b, 106c, the machine can determine that it is located within a region that may lack reliable satellite-based positioning information.

As an alternative or in addition to electronically-marked boundaries, boundaries 106a, 106b, 106c may be physically marked on job-site 100 using, for example, border markers, stakes, placards, and any other suitable technique for physically marking the area or region. As such, operators or passengers of machines 105 may be able to visually identify when the machine is located within a region that may lack reliable satellite-based positioning information.

Sub-regions defined by boundaries 106a, 106b, 106c may include one or more landmarks 108a, 108b, 108c and/or beacons 107a, 107b, 107c. Landmarks 108a, 108b, 108c may include fixed physical features within a sub-region whose location may be determined with substantial certainty and documented within a mapping database. As such, machines 105 may be able to retrieve and/or generate a map of the sub-region may using the location of the known landmarks 108a, 108b, 108c to supplement or compensate for uncertainty in the conventional positioning techniques (e.g., satellite-based positioning, dead reckoning, etc.) This may be particularly advantageous when, for example, detailed position information associated with a machine in job-site 100 may be required, such as when the machine is unable to determine the position of the machine with sufficient certainty using conventional positioning techniques or when the machine enters a hazardous area.

Landmarks 108a, 108b, 108c may include one or more immobile natural or artificial (e.g., man-made) features of the terrain, such as large trees or groups of trees, large land bodies (e.g., rocks, boulders, etc.), bodies of water (e.g., ponds, lakes, etc.), or any other natural feature of the terrain. Alternatively or additionally, landmarks 108a, 108b, 108c may include one or more immobile man-made features located within the sub-region such as, for example, buildings, sheds, pieces of equipment, machines, refueling areas, or any other man-made feature located within job-site 100.

The location of landmarks 108a, 108b, 108c may be determined using any suitable technique for locating physical objects within a job-site 100. For example, landmarks 108a, 108b, 108c may each be located by way of a detailed geological survey of the region, similar to a survey used for generating a conventional map of a region. Alternatively or additionally, the locations of landmarks 108a, 108b, 108c may be determined using laser-, RF-, or microwave-based locating techniques.

As an alternative or in addition to landmarks 108a, 108b, 108c, sub-regions may include one or more beacons 107a, 107b, 107c. Beacons 107a, 107b, 107c may include “active” positioning devices that emit light energy (e.g., laser, LED), RF or microwave energy, or acoustic (sound) energy that can be detected by one or more corresponding sensors aboard machines 105. As such, machines 105 may responsively determine the location of beacons within a sub-region and, based on the location of these beacons, responsively generate a map of the surrounding area. It is contemplated that the locations of beacons 107a, 107b, 107c may also be determined in a manner similar to that of landmarks 108a, 108b, 108c. Similarly, it is contemplated that landmarks 108a, 108b, 108c may be configured or adapted as beacons 107a, 107b, 107c.

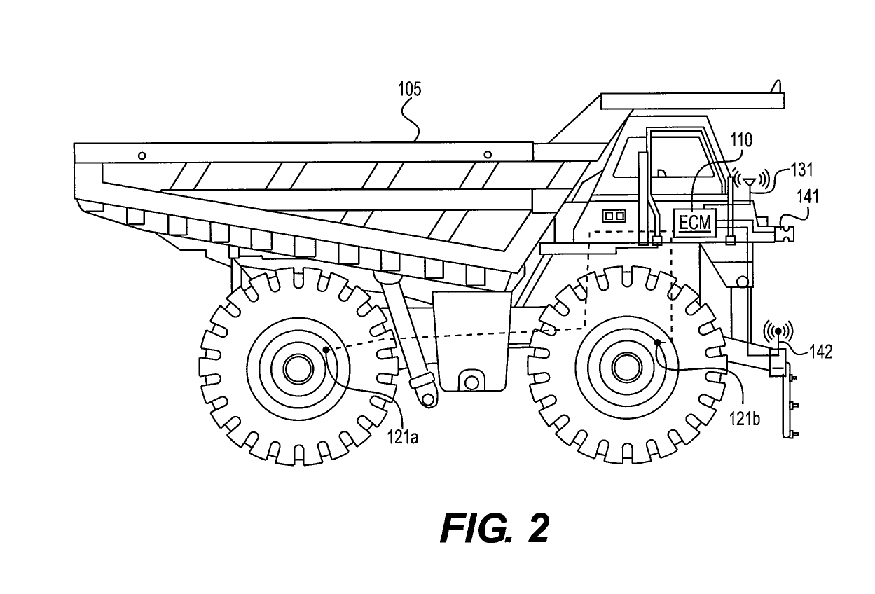

FIG. 2 illustrates an exemplary one of machines 105 that may be employed in job-site 100. Machines 105 may include manually-operated machines, autonomous machines, a combination of manually-operated and autonomous machines, or machines that may be operated in both manually-operated or autonomous mode. Manually-operated machines, as the term is used herein, refers to machines that are capable of being operated by a human or robotic operator that is located in an operator station of the machine. Alternatively or additionally, a manually-operated machine may include an on-board electronic control system that is adapted for operation by a remote control device by an external (off-board) equipment operator, such as an off-board human operator.

Autonomous machines, as the term is used herein, refers to a machine that is capable of controlling primary operational functions using an automated or semi-automated control system that does not require input from a human operator. For example, autonomous machine may include machines that are configured to operate without an operator being located in the operator console of the machine. Alternatively or additionally, autonomous machines may include machines having an on-board operator, but may be switched to autonomous mode to perform certain processes during the operation cycle (e.g., repetitious or routine functions or processes). For example, an autonomous machine may embody a machine having on-board or off-board electronic supervisory systems that are capable of directing and/or controlling operation and/or movement of the machine. According to one embodiment, an autonomous machine may include an on-board electronic control system that is configured to fully operate the machine in conjunction with one or more other electronic systems such as, for example, inertial navigation systems, collision avoidance systems, path planning and guidance systems, task assignment systems, and other types of systems for controlling operation of the machine. In such embodiments, the autonomous machine receives commands registered by the off-board equipment operator on a remote control console and operates the machine in accordance with the registered commands.

It is contemplated that some machines may be limited to operate exclusively in a manual mode, and cannot be operated in autonomous mode. Similarly, it is contemplated that some machines may be limited to operate exclusively in autonomous mode, and cannot be operated in a manual mode. It is also contemplated that some machines may be operated in both a manually-operated mode and an autonomous mode. Such machines may be configured to switch between manual and autonomous operation, depending upon a variety of different criteria.

According to one exemplary embodiment, a “dual-mode” machine (i.e., a machine that is configured to operate in both manual mode and autonomous mode) may be designated to primarily operate in the job-site in a manual mode, with a human operator. However, in certain situations, the machine may be switched to an autonomous mode of operate based on certain operational aspects of the machine. For example, if a manually-operated machine deviates from an authorized course of operation (i.e., path, speed, direction, etc.) by more than a threshold acceptable level, the machine may be switched to an autonomous mode of operation (in which one or more supervisory systems of the machine is configured to operate the machine according to the authorized course of operation) until the machine is restored to its authorized course of operation.

According to another exemplary embodiment, some “dual-mode” machines may be designated to operate primarily in an autonomous mode. However, in certain situations, the machine may be switched (e.g., with a manual pass code) to operate in a manual mode. For example, during service or maintenance of the machine, it may be practical for the technician to operate the machine manually. Alternatively, autonomous machines may be configured to automatically shut-down or become disabled in the event of an abnormal operating condition. In such situations, a service technician or manual operator may be authorized to override the shut-down, remove the machine from the job-site, and diagnose the abnormal condition. After repair, the machine may be re-integrated into the job-site in a manual mode (e.g., with a human operator) or in an autonomous mode. In some situations, the re-integrated machine may be placed in a “probationary” operational state for some predetermined time period, whereby the machine is allowed to operate in a limited capacity (e.g., with speed limits, payload limits, geographical limits, pitch/roll limits, time-of-operation limits, etc.) After the probationary period, the machine may be fully re-integrated into the job-site, in either autonomous mode or manual mode.

It is contemplated that, although certain “dual mode” machines are described as being operated primarily in either manual mode or autonomous mode (except in “certain situations”) such a description is exemplary only. Indeed, in many situations, selection between manual mode and autonomous mode may be dictated by many factors including, for example: the needs of the job-site, the nature and schedule of the tasks to be performed at the job-site, the suitability of the job-site environment for human operators, and/or the staffing limitations and requirements for the job-site.

Machines 105 may each include an electronic control module (ECM) 110. ECM 110 may be a processor-based controller adapted to perform various communication, analytical, and/or control functions associated with machine 105. For example, ECM 110 may be configured to receive data input from a plurality of components and subsystems (e.g., engine, transmission, navigation system, position sensors, etc.) of machine 105, analyze the received data input, and determine, based on the analysis, an appropriate response to the received data input.

Among other things, machines 105 may each include one or more systems and components for determining the position of the machine within job-site 100, consistent with the exemplary disclosed embodiments. For example, machine may include a satellite-based positioning system transceiver 131 for determining the position of the machine using conventional satellite-based positing technology, such as GPS, GLOSNASS, Compass, Galileo, or any other suitable satellite-based technology.

Alternatively or in addition to satellite-based positioning equipment, machines 105 may include one or more optical sensors 141 for receiving optical information associated with an area proximate machine 105. Optical sensors 141 may include, for example, a still or video image capture device, a laser scanning sensor, an LED sensor, or any other suitable device for collecting optical information from an area surrounding the machine. As will be explained in greater detail below, optical information may be used to determine the machine's position based on iterative analysis of a plurality of optical data recorded from the areas surrounding the machine over a period of time.

Machines 105 may be equipped with other position sensors 142 for determining the position of the machine. Position sensors 142 may include one or more RF sensors, microwave sensors, sonar sensors, thermal detection sensors, or any other suitable device for measuring energy surrounding the machine in order to identify the machine's surroundings. For example, machines 105 may include RF position sensors that emit RF energy and measure feedback in response to the emitted energy. Based on the received information, the machine may generate an energy profile of the area surrounding the machine to determine what, if anything, is located in the area surrounding the machine. This information may be used to determine the position of the machine and/or to navigate the machine within job-site 100.

It is contemplated that machines 105 may include additional, different, and/or fewer sensors for determining a position of a machine than those listed above. For example, machines 105 may include one or more gyroscopes, accelerometers, or any other suitable sensor for estimating machine position, either alone or in combination with position data from other systems or sensors.

According to one exemplary embodiment, machines 105 may include one or more wheel position sensors 121a, 121b for estimating the distance traveled by one or more of the wheels of the machine. By estimating a change in the distance traveled by each wheel over a given period of time, the machine may estimate the current position by extrapolating the estimated distance traveled from a previously-known position of the machine using, for example, a dead reckoning algorithm. Although the accuracy of position estimates using dead reckoning techniques may degrade over time, such a positioning system may advantageously provide redundancy in case of a temporary failure of one or more other positioning techniques.

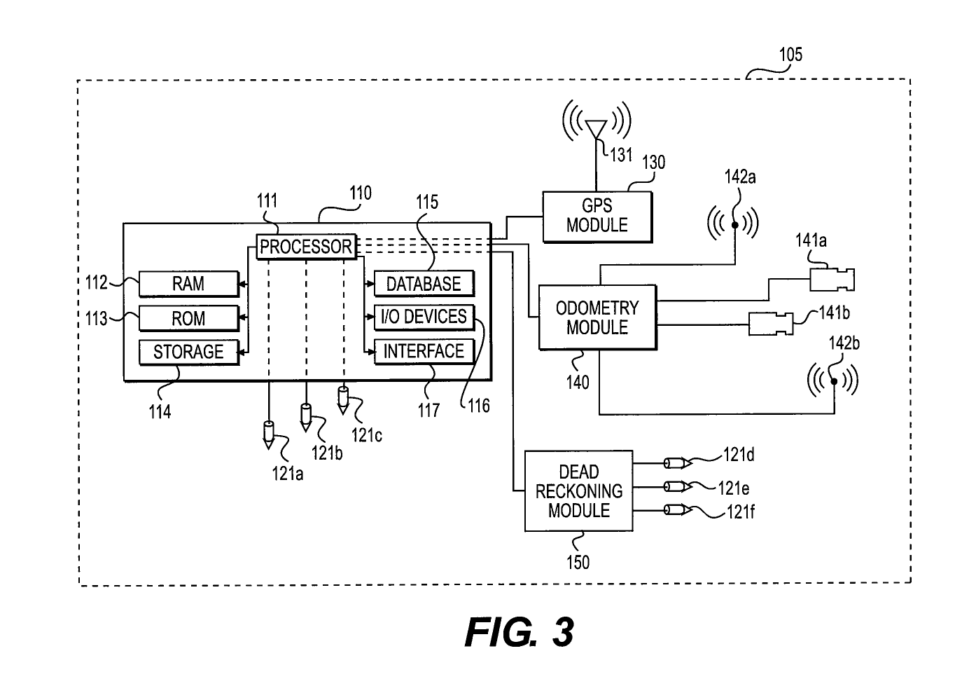

FIG. 3 provides a provides a detailed schematic diagram of certain components associated with an exemplary positioning system associated with machines 105, consistent with the disclosed embodiments. According to one exemplary embodiment, machines 105 may include one or more modules for estimating the position of the machine such as, for example, a GPS module 130, an odometry module 140, and/or a dead reckoning module 150. Machines 105 may also include ECM 110 that is communicatively coupled with one or more of the position-estimating modules and configured to determine the machine's position within job-site 100. Machines 105 may include additional, fewer, and/or different components than those listed above. For example, machines 105 may include one or more sensors 121a-121f for monitoring data from the machine or the surrounding environment that may be used in estimating machine position.

ECM 110 may include any type of processor-based system in which processes and methods consistent with the disclosed embodiments may be implemented. For example, as illustrated in FIG. 3, ECM 110 may include one or more hardware and/or software components configured to execute software programs, such as software for estimating the position of the machine based on available machine position information. For example, ECM 110 may include one or more hardware components such as, for example, a central processing unit (CPU) (processor 111), a random access memory (RAM) module 112, a read-only memory (ROM) module 113, a storage system 114, a database 115, one or more input/output (I/O) devices 116, and a network interface 117. Alternatively and/or additionally, ECM 110 may include one or more software components such as, for example, a computer-readable medium including computer-executable instructions for performing methods consistent with the disclosed embodiments. It is contemplated that one or more of the hardware components listed above may be implemented using software. For example, storage 114 may include a software partition associated with one or more other hardware components of ECM 110. ECM 110 may include additional, fewer, and/or different components than those listed above. It is understood that the components listed above are exemplary only and not intended to be limiting.

Processor 111 may include one or more processors, each configured to execute instructions and process data to perform one or more functions associated with ECM 110. As illustrated in FIG. 1, processor 111 may be communicatively coupled to RAM 112, ROM 113, storage 114, database 115, I/O devices 116, and network interface 117. Processor 111 may be configured to execute sequences of computer program instructions to perform various processes, which will be described in detail below. The computer program instructions may be loaded into RAM for execution by processor 111.

RAM 112 and ROM 113 may each include one or more devices for storing information associated with an operation of ECM 110 and/or processor 111. For example, ROM 113 may include a memory device configured to access and store information associated with ECM 110, including information for identifying, initializing, and monitoring the operation of one or more components and subsystems of ECM 110. RAM 112 may include a memory device for storing data associated with one or more operations of processor 111. For example, ROM 113 may load instructions into RAM 112 for execution by processor 111.

Storage 114 may include any type of mass storage device configured to store information that processor 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by ECM 110 and/or processor 111. For example, database 115 may include a repository of detailed maps associated with one or more of the sub-regions of job-site 100. It is contemplated that database 115 may store additional and/or different information than that listed above.

I/O devices 116 may include one or more components configured to communicate information with a user associated with ECM 110. For example, I/O devices 116 may include a console with an integrated keyboard and mouse to allow a user to input parameters associated with ECM 110. I/O devices 116 may also include a display including a graphical user interface (GUI) for outputting information on a monitor. I/O devices 116 may also include peripheral devices such as, for example, a printer for printing information associated with ECM 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Network interface 117 may include one or more components configured to transmit and receive data via a communication network, such as the Internet, a local area network, a workstation peer-to-peer network, a direct link network, a wireless network, or any other suitable communication platform. In this manner, ECM 110 may communicate with one or more external devices through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, network interface 117 may include one or more modulators, demodulators, multiplexers, demultiplexers, network communication devices, wireless devices, antennas, modems, and any other type of device configured to enable data communication via a communication network.

Machines 105 may include one or more sensors 121a-121f, such as wheel position sensors 121a, 121b and/or other sensors 121c-121f for collecting position information associated with the machine. Sensors 121c-121f may include, for example, gyroscopes, accelerometers, inclinometers, wheel position sensors, proximity sensors, rotary encoders, inertial sensors, speed sensors, magnetometer, or any other suitable sensor for estimating, either alone or in combination with other information, a position, location, direction, elevation, velocity, acceleration, or any other parameter that can be used to aid in locating and/or navigating the machine within job-site 100.

Sensors 121a-121f may be communicatively coupled to ECM 110, either directly or through one or more other components or subsystems. For example, as illustrated in FIG. 3, one or more sensors, such as sensors 121a-121c, may be communicatively coupled directly to processor 111 of ECM 110.

Alternatively or additionally, one or more sensors, such as sensors 121d-121f may be communicatively coupled to a data analysis module, such as dead reckoning module 150. The data analysis module may, in turn, be communicatively coupled to processor 111 of ECM 110. It is contemplated that, in this embodiment, raw and/or processed information from sensors 121d-121f may be accessible by processor 111 via the connection through the data analysis module.

Machines 105 may include one or more modules for collecting and analyzing machine position information. For example, machines 105 may include one or more of a GPS module 130, an odometry module 140, and a dead reckoning module 150. Each of these modules may be communicatively coupled to processor 111 of ECM 110 and configured to provide the collected and/or analyzed machine position information to ECM 110.

GPS module 130 may include a transceiver 131 that is configured to communicate with a corresponding positioning satellite to determine the location of the machine. Although referred to as a “GPS” module herein, it is contemplated that “GPS” is not limited to the GPS system used in North America. Rather, GPS is used to refer to any satellite-based positioning technology (such as GLOSNASS, Compass, Galileo, etc.) in which a remote transceiver communicates with an orbital satellite to estimate the location of the remote transceiver. In addition to location, GPS module 130 may be configured to determine other data associated with the transceiver, such as speed, elevation, and other types of data that can be derived from the location information.

Odometry module 140 may embody any device that receives position information and responsively estimates a change in position over time relative to a known starting location. According to one embodiment, odometry module 140 may be coupled to one or more cameras 141a, 141b and configured to receive time-sequenced images from cameras 141a, 141b. Based on the image information, odometry module 140 may use sequential images to determine information about the machine and the surrounding areas. For example odometry module 140 may be configured to estimate the distance traveled by the machine over time, based on the image information. Alternatively or additionally, odometry module 140 may use the image information to generate a detailed map of the surrounding area, based on known features of the terrain, such as landmarks 108a, 108b, 108c or beacons 107a, 107b, 107c.

As an alternative or in addition to cameras 141a, 141b, odometry module 140 may be communicatively coupled to RF, microwave, laser, thermal, and/or sonar odometry sensors 142a, 142b. According to one embodiment, sensors 142a, 142b may be configured to radiate energy and measure feedback from the surrounding area in response to the radiated energy. Sensors 142a, 142b may pass the measured feedback information to odometry module 140, which may generate a corresponding profile or “map” of the area surrounding the machine. Based on this map information compared with known map information (such as such as landmarks 108a, 108b, 108c or beacons 107a, 107b, 107c), odometry module 140 may be configured to estimate the position of the machine.

Dead reckoning module 150 may be communicatively coupled to position sensors 121d-121f and may be configured to estimate the machine position based on the information from position sensors 121d-121f. According to one embodiment, position sensors 121d-121f may be rotary sensors coupled to the wheels of the machine and configured to measure the distance traveled by the respective wheel. Dead reckoning module 150 may be configured to estimate the bearing and the distance traveled by the machine based on the information received from position sensors 121d-121f. Dead reckoning module 150 may estimate the position of the machine by extrapolating the estimated bearing and distance information from a previously-known position of the machine.

The position estimation embodiments described above with respect to GPS module 130, odometry module 140, and dead reckoning module 150 have varying degrees of accuracy, depending upon the availability of reliable position information. For example, GPS and other satellite-based positioning technologies, when available, typically render more reliable location results than dead reckoning technologies. However, when satellite-based positioning technologies become interrupted due, for example, to loss of communication with the orbital satellite, GPS location information may become inaccurate and, more often, inaccessible.

Odometry and other map-based positioning techniques, while reliable, tend to be computationally intensive and consume large amounts of available processing power of the machine. As such, odometry and map-based positioning techniques may be impractical for use by the machine on a full-time basis.

Dead reckoning systems are significantly less computationally intensive than odometry and map-based positioning techniques. However, they are particularly susceptible to fairly large error over time. As such, dead reckoning positioning techniques may only be reliable for relatively short periods of time such as, for example, when GPS positioning systems are temporarily interrupted.

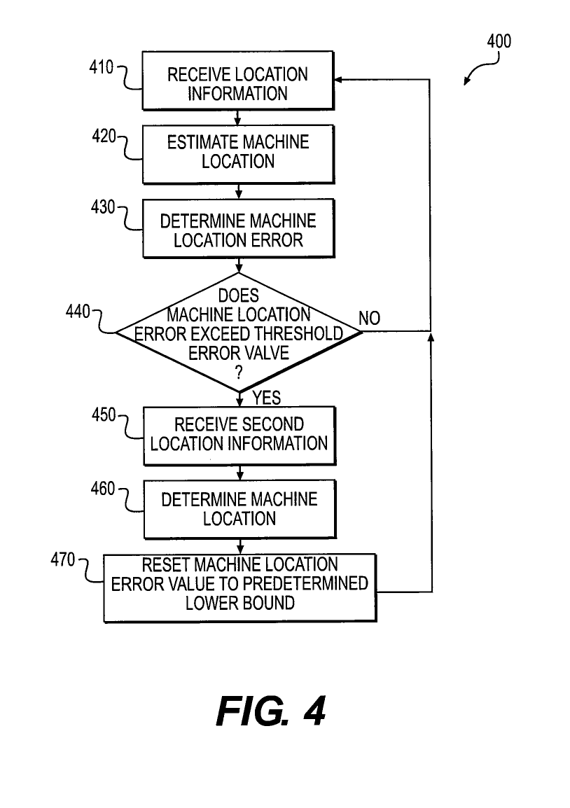

Processes and features consistent with the disclosed embodiments provide a system and method for determining the position of the machine by determining the reliability of the available machine position information and selecting a positioning technique based on the determined reliability. Accordingly, when one or more positioning techniques is unable to reliably determine machine position information, one or more other positioning techniques may be employed to determine the machine's position. FIG. 4 provides a flowchart 400 illustrating an exemplary method for determining machine position information.

As illustrated in FIG. 4, the process commences upon receipt of machine location information by a processor 111 of ECM 110 (Step 410). As explained, machine location information may be any information that can be used to estimate, calculate, and/or derive machine location information. For example, machine location information may include GPS location information received by transceiver 131 from an orbital positioning satellite. Alternatively or additionally, machine location information may include information from one or more sensors 121a-121f, or information from one or more of odometry module 140 or dead reckoning module 150.

Based on the received location information, processor 111 may estimate a location of the machine (Step 420). For example, processor 111 may estimate the machine location based on received GPS location information that may be available. Alternatively or additionally, processor 111 may estimate the machine's location using dead reckoning techniques based on information received from dead reckoning module 150. According to another embodiment, processor 111 may determine the machine's position based on odometry data received from odometry module 140.

The particular technique that is used for estimating the position of the machine may be based on the availability of the respective location information. For example, if GPS information is not available, processor 111 may estimate the machine's position based on dead reckoning or odometry techniques. As will be described in detail below, the technique for estimating the position of the machine may also be based on the reliability of the location information.

After estimating the machine's location, processor 111 may determine an error associated with the estimated location (Step 430). The determined error may be based on several factors, such as the precision of the sensor(s) used to detect the location information and the method used to estimate the location. It is contemplated that certain positioning techniques, such as dead reckoning, are less reliable than other techniques, such as odometry and GPS techniques. As such, processor 111 may be configured to calculate or assign predetermined error values on the basis of the method used to estimate the location.

In addition to determining error based on the method used to estimate the location of the machine, processor 111 may also determine the error based, at least in part, on certain machine-specific criteria. For example, one or more sensors 121a-121f on the machine may not function properly. If processor 111 determines that all or part of the received sensor data may be corrupted, the error may be increased to compensate for the corrupted data.

Processor 111 may be configured to monitor the determined error over time. That is, processor 111 may add the error associated with the current machine location estimate to the cumulative error associated with preceding machine location estimate(s). As a result, processor 111 can monitor the cumulative error estimate as the machine is travelling throughout job-site.

Processor 111 may be configured to compare the error associated with the estimated machine location with a threshold error value (Step 440). According to one embodiment, processor 111 may compare the cumulative error estimate with a threshold cumulative error value. Alternatively or additionally, processor 111 may be configured to compare the estimated error value associated with the most recent estimate of the machine location with a threshold “single” error value. If neither of the machine location estimates exceeds the respective threshold error value (Step 440: No), processor 111 returns to Step 410 to await the next set of position location information.

If, however, processor 111 determines that either of the machine location estimates exceeds its respective threshold error value (Step 440: Yes), processor 111 may receive second location information (Step 450). The second location information may be received in response to processor 111 performing a Simultaneous Localization And Mapping (“SLAM”) technique. The SLAM technique involves generating or downloading a detailed map of the surrounding area. This detailed map includes precise location information associated with many features of the surrounding area. As a result, processor 111 is able to more accurately determine the machine's location relative to the other features on the map (Step 460).

According to one embodiment, the SLAM technique may involve determining the location of the machine by estimating the distance and orientation of the machine relative to one or more landmarks 108a, 108b, 108c or beacons 107a, 107b, 107c. Because the location of landmarks 108a, 108b, 108c and beacons 107a, 107b, 107c are precisely mapped, processor 111 can resolve the location of the machine with relatively high accuracy using the existing location sensor information relative to the known locations of landmarks and/or beacons, using known statistical and data resolution techniques such as, for example, Kalman filtering, Monte Carlo methods, and/or scan matching techniques.

According to another embodiment, processor 111 may compare visual odometry information (such as images and video clips) with features outlined on the detailed map to determine the machine's position relative to the known locations of the features on the map. By downloading and analyzing the received odometry information with respect to the features contained in the detailed map, the SLAM technique allows processor 111 to more accurately determine the machine's position. Because the SLAM technique results in a substantially more accurate position estimate processor 111 may reset the machine position error value(s) to a predetermined lower bound (Step 470). Processor 111 then returns to Step 410 to await the next set of position location information.

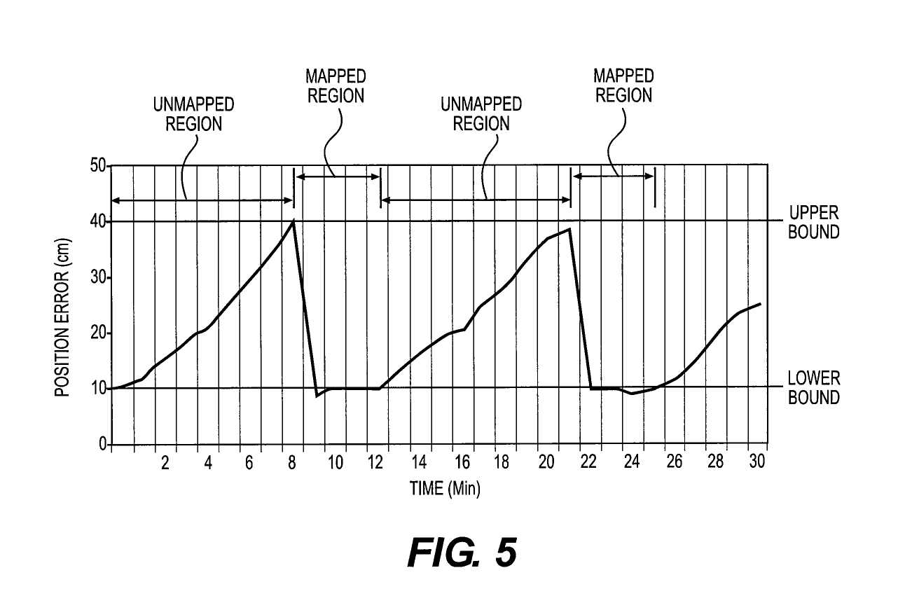

FIG. 5 depicts an exemplary timing diagram consistent with certain processes described in accordance with the disclosed embodiments. More particularly, FIG. 5 provides an illustration of exemplary measurement of position error that accumulates over time as a machine travels through unmapped and mapped regions of job-site 100. Unmapped regions of job-site 100 correspond generally to areas outside boundaries 106a, 106b, 106c associated with the sub-regions shown in FIG. 1. Mapped regions of job-site 100 correspond generally to areas within boundaries 106a, 106b, 106c of job-site 100 of FIG. 1. As explained above, mapped regions include areas in which full or detailed maps of the job-site are generated and/or are available for download.

As illustrated in FIG. 5, when the machine travels through an unmapped region, the estimated machine position error increases with respect to time. This is due to the error in the precision of the methods and/or data used to estimate the location of the machine. When the error exceeds to the threshold error value (“upper bound”), processor 111 performs the SLAM technique to obtain a detailed map of the surrounding area. The map is used to identify the precise location of the machine based on the machine's position relative to known landmarks 108a, 108b, 108c and beacons 107a, 107b, 107c located within the mapped region.

As can be seen from FIG. 5, when the machine leaves the first “mapped” region (at approximately 12 minutes), the error associated with the estimated location again begins to accumulate. This accumulation of error is based on the “expiration” of the SLAM that was performed within the “mapped” region. The error continues to accumulate until the machine reaches another “mapped” region, where a full SLAM can be performed to reset the accumulated error to the lower bound.

It is contemplated that the size and location of the mapped regions can be strategically dispersed throughout job-site 100 so machines 105 can perform the SLAM technique at predetermined intervals, corresponding to when the estimated error is expected to reach a threshold limit. Alternatively or additionally, the location of the mapped regions may be selected as areas in which there may be particularly hazardous conditions that require more precise machine location estimates. For example, a mapped region may be selected in high-traffic areas or areas where clearances are particularly small (e.g., automatic loading/unloading zones, narrow roadways, etc.). As such, regardless of the amount of error accumulation, a full SLAM may be performed to ensure that the location error is reduced to a relatively low level (e.g., “lower bound”) while the machine is within the mapped region.

### INDUSTRIAL APPLICABILITY

The hybrid systems and methods for determining the position of a machine consistent with embodiments disclosed and described herein allows the machine to use a first, less precise technique to estimate the position of the machine until the positioning error reaches a threshold value, at which point a second, more precise technique is used to determine the position of the machine. Accordingly, the presently disclosed hybrid positioning system enables users to balance the need for maintaining precise machine position information, without unduly burdening the machine's processing resources by unnecessarily using more computationally-intensive positioning techniques.

The presently disclosed hybrid positioning system may have several advantages. Specifically, the hybrid positioning systems and methods consistent with the disclosed embodiments may reduce the processing and memory requirements associated with using map-based SLAM systems as the primary “full-time” positioning technique associated with the machine. By using SLAM-based techniques on an ad-hoc basis in response specific predefined criteria, processing resources and system memory may be reserved for other machine processes (e.g., navigation, autonomous operation, performance analysis, etc.).

Furthermore, the hybrid positioning system consistent with the disclosed embodiments may reduce machine costs. Specifically, by reducing the complexity of the positioning and navigation system, the machine may be able to use simpler, less sophisticated, and less expensive processors and memory modules.

It will be apparent to those skilled in the art that various modifications and variations can be made to the disclosed systems and associated methods for determining the position of a machine within a job-site. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for determining a position of a machine within a job site, comprising:
receiving first information indicative of a location of the machine;
estimating, by a processor coupled to the machine, a location of the machine based on the received first information using a first positioning technique;
determining, by the processor, a first error value associated with the estimated location of the machine;
comparing, by the processor, the first error value with a threshold error level;
if the first error value exceeds the threshold error level:
receiving second information indicative of the location of the machine; and
determining, by the processor, the location of the machine based on the received second information, wherein the location of the machine is determined using a second positioning technique.

2. The method of claim 1, wherein the information indicative of the location of the machine includes location information determined by a satellite-based positioning device associated with the machine.

3. The method of claim 1, wherein receiving the information indicative of the location of the machine includes receiving, from one or more sensors mounted on the machine, information indicative of the proximity of the machine to one or more objects located in the job site.

4. The method of claim 3, wherein estimating the location of the machine includes estimating the location of the machine based, at least in part, on a last known position of the machine and the information from the one or more sensors.

5. The method of claim 1, wherein first information indicative of the location of the machine includes current speed and heading information associated with the machine.

6. The method of claim 5, wherein the first positioning technique is a dead reckoning location technique, whereby the location of the machine is estimated based on a previously-stored location of the machine and the current speed and heading information associated with the machine.

7. The method of claim 1, wherein first information indicative of the location of the machine includes image information collected by one or more sensors on the machine.

8. The method of claim 7, wherein the image information is one or more of RF or optical image information collected from one or more of respective RF or optical image sensors.

9. The method of claim 7, wherein the first positioning technique includes a visual odometry technique and determining the location of the machine includes estimating the location of the machine based on an analysis of image information from sequential images.

10. The method of claim 1, wherein receiving second information indicative of the location of the machine includes:
identifying, based on the information indicative of the location of the machine, at least one landmark proximate the machine; and
selecting, by the processor, a map portion associated with the at least one identified landmark.

11. The method of claim 10, wherein the second positing technique includes a SLAM technique, comprising:
identifying a location of a plurality of landmarks shown in the selected map portion;
determining a distance and an orientation of the machine relative to each of the plurality of landmarks; and
determining the location of the machine based on the distance and orientation of the machine relative to each of the plurality of landmarks.

12. A method for determining a position of a machine in a job site, comprising:
receiving information indicative of a location of the machine;
estimating, by a processor coupled to the machine, a location of the machine based on the received information;
determining, by the processor, a first error value associated with the estimated location of the machine;
comparing, by the processor, the first error value with a threshold error level;
if the first error exceeds the threshold error level:
identifying, based on the information indicative of the location of the machine, at least one landmark proximate the machine;
selecting, by the processor, a map portion associated with the at least one identified landmark;
analyzing, by the processor, the selected map portion and the received information indicative of the location of the machine; and
determining the location of the machine based on the analysis.

13. The method of claim 12, further including:
if the first error does not exceed the threshold error level:
receiving second information indicative of a location of the machine;
determining, by the processor, the location of the machine based on the received second information;
estimating, by the processor, a second error in the determined location of the machine; and
comparing, by the processor, a current error with a threshold error level, the current error based at least in part on the first error and the second error.

14. The method of claim 12, wherein analyzing the selected map portion and the received information indicative of the location of the machine includes:
identifying a location of a plurality of landmarks shown in the selected map portion;
determining a distance and an orientation of the machine relative to each of the plurality of landmarks; and
determining the location of the machine based on the distance and orientation of the machine relative to each of the plurality of landmarks.

15. The method of claim 12, wherein receiving information indicative of a location of the machine includes monitoring at least one of latitude, longitude, and elevation information by a satellite-based global positioning transceiver associated with the machine.

16. A system for determining a position of a machine in a job site, comprising:
at least one position monitoring device configured to collect information indicative of a location of the machine;
a processor, communicatively coupled to the at least one position monitoring device and configured to:
estimate a location of the machine based on the received information using a first positioning technique;
determine a first error value associated with the estimated location of the machine;
compare the first error value with a threshold error level;
if the first error value exceeds the threshold error level:
receive second information indicative of the location of the machine; and
determine the location of the machine based on the received second information, wherein the location of the machine is determined using a second positioning technique.

17. The system of claim 16, wherein the at least one position monitoring device includes a satellite-based positioning module configured to determine latitude and longitude information associated with the machine.

18. The system of claim 16, wherein the at least one position monitoring device includes a wheel position sensor wherein the processor is further configured to:
estimate, based on data measured by the wheel position sensor, a distance traveled by the machine; and
estimate the location of the machine based, at least in part, on a last known position of the machine and the estimated distance traveled by the machine.

19. The system of claim 16, wherein the at least one position monitoring device includes an odometry module configured to estimate the location of the machine based on one or more of RF or optical image information collected from one or more of respective RF or optical image sensors.

20. The system of claim 16, wherein receiving second information indicative of the location of the machine includes:
identifying, based on the information indicative of the location of the machine, at least one landmark proximate the machine; and
selecting, by the processor, a map portion associated with the at least one identified landmark.

21. The system of claim 20, wherein the second positing technique includes a SLAM technique, wherein the processor is further configured to:
identify a location of a plurality of landmarks shown in the selected map portion;
determine a distance and an orientation of the machine relative to each of the plurality of landmarks; and
determine the location of the machine based on the distance and orientation of the machine relative to each of the plurality of landmarks.
